(19) United States
(12) Patent Application Publication
(10) Pub. No.: US 2021/0158386 A1
(43) Pub. Date: May 27, 2021

(54) ELECTRONIC METHODS AND SYSTEMS FOR PROVIDING LOYALTY PROGRAMS TO MERCHANTS FOR THEIR CUSTOMERS

(71) Applicant: MASTERCARD INTERNATIONAL INCORPORATED, PURCHASE, NY (US)

(72) Inventors: Sameer Sanjay PATHAK, Maharashtra (IN); Akshay CHOUDHARY, Pune (IN); Rajeev KUMAR, Varanasi (IN)

(21) Appl. No.: 17/004,149

(22) Filed: Aug. 27, 2020

(30) Foreign Application Priority Data
Nov. 27, 2019 (IN) 201941048538

(51) Int. Cl. G06Q 30/02

(52) U.S. Cl. CPC G06Q 30/0227; G06Q 30/0238; G06Q 30/0233; G06Q 30/0236

(57) ABSTRACT

Embodiments provide methods and systems for providing a loyalty program to a merchant. The loyalty program is created using a loyalty program ruleset. The loyalty program ruleset is accessed using a merchant identifier of a merchant and a unique identifier data of a user. The unique identifier is captured from a payment card of the user by a merchant terminal. Further, a payment amount for a payment transaction of the user is mapped into a loyalty point data using the loyalty program ruleset. After the mapping, a redeemability of total redeemable loyalty points from the loyalty point data is determined. After determining the redeemability, a redeemable loyalty points is deducted from the total redeemable loyalty points based on a pre-defined number of loyalty points. The payment amount is adjusted based on the redeemable loyalty points. The loyalty program ruleset is also used for determining loyalty reward points for the user.

### CROSS-REFERENCE TO RELATED APPLICATION

This application claims priority to India Application No. 201941048538, filed Nov. 27, 2019, entitled “Electronic Methods and Systems for Providing Loyalty Programs to Merchants for Their Customers”, the entirety of which is incorporated herein by reference.

### TECHNICAL FIELD

The present disclosure generally relates to a payment technology and, more particularly to, methods and systems for providing a loyalty program to merchants for their customers.

### BACKGROUND

Nowadays, a loyalty program is important to both merchants as well as customers. The loyalty program is a reward scheme that is offered by a merchant to his customers who repeatedly visit the merchant for purchasing. For instance, the loyalty program may provide a customer coupons, cashback offers, customer incentive points, discounts, or the like. The merchant may retain the customers by offering a variety of loyalty programs. This may encourage the customers to repeatedly visit the merchant. Moreover, these customers may recommend others to purchase from the merchant using the loyalty programs. This improves business and reputation of the merchant as well as increases rate of customer retention for the merchant. Typically, the merchant may provide the loyalty programs to the customers by issuing physical cards, such as loyalty cards. The merchant may spend a lot of resources to generate and promote the loyalty cards.

However, some merchants may face difficulty in setting up the loyalty programs for their customers. For instance, merchants who own small businesses, such as street-stall vendors, food vendors, or like may not be able to afford the loyalty programs. The generation and promotion of the loyalty programs may also be expensive for these merchants. In some cases, a customer may be required to carry multiple loyalty cards provided by a merchant, which may be cumbersome and inconvenient. In case the customer loses a loyalty card, then the customer may be required to enquire about the lost loyalty card. The customer may visit the merchant and request to regenerate the loyalty card. However, regeneration of the loyalty card may be time-consuming and a mundane task for both the customer and the merchant. This may affect experience of the customer and the customer may visit a different merchant. Consequently, business and reputation of the merchant may be at stake if the merchant loses the customer.

Therefore, there exists a need to provide a technical solution for providing a loyalty program to a merchant in a feasible and efficient manner. It would be advantageous for the merchant to retain his customers through the loyalty program, without having the need to issue the loyalty program in any physical form.

### SUMMARY

Various embodiments of the present disclosure provide systems and methods for providing a loyalty program to a merchant.

In an embodiment, a computer-implemented method for providing a loyalty program to a merchant is disclosed. The method includes receiving, by a server system associated with a payment network, a payment transaction request signal from a merchant terminal. The payment transaction request signal includes a unique identifier data associated with a user and a payment amount for a payment transaction to a merchant. The unique identifier is stored in a payment card of the user. The method includes accessing, by the server system, a merchant identifier data associated with the merchant upon successful authorization of the payment transaction request signal. The method includes accessing, by the server system, a loyalty program ruleset for the loyalty program using the merchant identifier data and the unique identifier data. The method includes updating, by the server system, the payment amount based on the loyalty program ruleset. The method includes sending, by the server system, an updated payment transaction request signal based on the updated payment amount to an issuer of the user via the payment network. The method further includes notifying, by the server system, a completion of the payment transaction upon receipt of the updated payment amount from the issuer.

In another embodiment, a server system for providing a loyalty program to a merchant is disclosed. The system includes a memory and a processor. The memory includes stored instructions. The processor is configured to execute the stored instructions to cause the server system to perform at least in part to receive a payment transaction request signal from a merchant terminal. The payment transaction request signal includes a unique identifier data associated with a user and a payment amount for a payment transaction to a merchant. The unique identifier is stored in a payment card of the user. The server system is caused to perform at least in part to access a merchant identifier data associated with the merchant upon successful authorization of the payment transaction request signal. The server system is caused to perform at least in part to access a loyalty program ruleset for the loyalty program using the merchant identifier data and the unique identifier data. The server system is caused to perform at least in part to update the payment amount based on the loyalty program ruleset. The server system is caused to perform at least in part to send an updated payment transaction request signal based on the updated payment amount to an issuer of the user via the payment network. The server system is further caused to perform at least in part to notify a completion of the payment transaction upon receipt of the updated payment amount from the issuer.

In yet another embodiment, a computer-implemented method for providing a loyalty program to a merchant is disclosed. The method includes receiving, by a server system associated with a payment network, a payment transaction request signal from a merchant terminal. The payment transaction request signal includes a unique identifier data associated with a user and a payment amount for a payment transaction to a merchant. The unique identifier is stored in a payment card of the user. The method includes accessing, by the server system, a merchant identifier data associated with the merchant upon successful authorization of the payment transaction request signal. The method includes accessing, by the server system, a loyalty program ruleset of the loyalty program using the unique identifier data and the merchant identifier data. The method includes mapping, by the server system, the payment amount into a loyalty point data using the loyalty program ruleset. The method includes determining, by the server system, a redeemability of a total redeemable loyalty points from the loyalty point data. The method includes updating, by the server system, the payment amount based on deducting the redeemable loyalty points. The method includes sending, by the server system, an updated payment transaction request signal based on the updated payment amount to an issuer of the user via the payment network. The method includes upon receipt of an approval of the payment transaction, determining, by the server system, loyalty reward points for the user using the loyalty program ruleset. The method includes updating, by the server system, a loyalty summary data for the loyalty program based on the loyalty reward points. The loyalty summary data is accessed using the merchant identifier data and the unique identifier data. The method further includes notifying, by the server system, the updated loyalty summary data to the merchant.

Other aspects and example embodiments are provided in the drawings and the detailed description that follows.

### BRIEF DESCRIPTION OF THE FIGURES

For a more complete understanding of example embodiments of the present technology, reference is now made to the following descriptions taken in connection with the accompanying drawings in which:

FIG. 1 illustrates an example representation of an environment related to at least some example embodiments of the present disclosure;

FIG. 2 is a sequence flow diagram of creating a loyalty program for a merchant using a loyalty program ruleset, in accordance with an example embodiment of the present disclosure;

FIG. 3 is a sequence flow diagram depicting a process flow of a payment transaction of a purchase item of a user using a loyalty program of the merchant, in accordance with an example embodiment of the present disclosure;

FIG. 4 is a flow chart of determining loyalty reward points for the user based on the loyalty program ruleset, in accordance with an example embodiment of the present disclosure;

FIG. 5 is a table representing a storage of unique identifiers of users at an issuer server, in accordance with an example embodiment of the present disclosure;

FIG. 6 is a table representing the loyalty program ruleset for generating the loyalty program of the merchant, in accordance with an example embodiment of the present disclosure;

FIG. 7 is a table representing a loyalty summary for the loyalty program, in accordance with an example embodiment of the present disclosure;

FIG. 8 is a flow diagram depicting a method for performing a payment transaction using a loyalty program of a merchant, in accordance with an example embodiment of the present disclosure;

FIGS. 9A and 9B, collectively, are a flow diagram depicting a method for performing a payment transaction using the loyalty program of the merchant, in accordance with another example embodiment of the present disclosure;

FIG. 10 is a simplified block diagram of a server system for providing the loyalty program to the merchant, in accordance with an embodiment of the present disclosure;

FIG. 11 is a simplified block diagram of an acquirer server providing the loyalty program to the merchant, in accordance with an embodiment of the present disclosure;

FIG. 12 is a simplified block diagram of an issuer server, in accordance with an embodiment of the present disclosure;

FIG. 13 is a simplified block diagram of a payment server, in accordance with an embodiment of the present disclosure; and

FIG. 14 is a simplified block diagram of a merchant terminal capable of implementing the various embodiments of the present disclosure.

The drawings referred to in this description are not to be understood as being drawn to scale except if specifically noted, and such drawings are only exemplary in nature.

### DETAILED DESCRIPTION

In the following description, for purposes of explanation, numerous specific details are set forth in order to provide a thorough understanding of the present disclosure. It will be apparent, however, to one skilled in the art that the present disclosure can be practiced without these specific details.

Reference in this specification to “one embodiment” or “an embodiment” means that a particular feature, structure, or characteristic described in connection with the embodiment is included in at least one embodiment of the present disclosure. The appearance of the phrase “in an embodiment” in various places in the specification is not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not for other embodiments.

Moreover, although the following description contains many specifics for the purposes of illustration, anyone skilled in the art will appreciate that many variations and/or alterations to said details are within the scope of the present disclosure. Similarly, although many of the features of the present disclosure are described in terms of each other, or in conjunction with each other, one skilled in the art will appreciate that many of these features can be provided independently of other features. Accordingly, this description of the present disclosure is set forth without any loss of generality to, and without imposing limitations upon, the present disclosure.

The term “payment account” used throughout the description refers to a financial account that is used to fund the financial transaction (interchangeably referred to as “payment transaction”). Examples of the payment account include, but are not limited to a savings account, a credit account, an e-wallet account, a checking account and a virtual payment account. The payment account may be associated with an entity such as an individual person, a family, a commercial entity, a company, a corporation, a governmental entity, a non-profit organization and the like. In some scenarios, a payment account may be a virtual or temporary payment account that can be mapped or linked to a primary payment account, such as those accounts managed by PayPal®, and the like.

The term “payment card”, used throughout the description, refers to a physical or virtual card linked with a financial or payment account that may be presented to a merchant or any such facility in order to fund a financial transaction via the associated payment account. Examples of the payment card include, but are not limited to, debit cards, credit cards, prepaid cards, virtual payment numbers, virtual card numbers, forex cards, charge cards, e-wallet cards, and stored-value cards. A payment card may be a physical card that may be presented to the merchant for funding the payment. Alternatively or additionally, the payment card may be embodied in form of data stored in a user device, where the data is associated with payment account such that the data can be used to process the financial transaction between the payment account and a merchant's financial account.

The term “payment network”, used throughout the description, refers to a network or collection of systems used for transfer of funds through use of cash-substitutes. Payment networks may use a variety of different protocols and procedures in order to process the transfer of money for various types of transactions. Transactions that may be performed via a payment network may include product or service purchases, credit purchases, debit transactions, fund transfers, account withdrawals, etc. Payment networks may be configured to perform transactions via cash-substitutes, which may include payment cards, letters of credit, checks, financial accounts, etc. Examples of networks or systems configured to perform as payment networks include those operated by Mastercard®, VISA®, Discover®, American Express®, etc.

### OVERVIEW

Various example embodiments of the present disclosure provide systems and methods for providing a loyalty program to a merchant that overcomes obstacles mentioned in the background section in addition to provide additional advantages. More specifically, techniques disclosed herein electronically create the loyalty program based on a loyalty program ruleset. The loyalty program ruleset is used for creating different loyalty programs for different merchants.

Initially, a merchant registers for a loyalty program to an acquirer of the merchant. In the registration, the merchant provides a merchant data, such as a merchant name, a merchant category code, a merchant brand name, a merchant address, a contact number of the merchant and a payment account of the merchant. The acquirer assigns a merchant identifier to the merchant, upon receipt of the merchant data. The merchant data is stored in a database using the merchant identifier. Further, the acquirer determines at least one loyalty computation function using one or more loyalty calculation parameters and one or more loyalty redemption parameters. The loyalty computation function is used for generating a loyalty program ruleset. The loyalty program ruleset is used for creating the loyalty program for the merchant. After the creation of the loyalty program, a loyalty summary for the loyalty program is generated. The loyalty program ruleset and the loyalty summary data are stored in the database. When a user visits the merchant, the loyalty program is provided to the user.

In an illustrative example scenario, the merchant swipes a payment card of the user at a merchant terminal. When the payment card is swiped, the merchant terminal captures a unique identifier data from the payment card. The unique identifier data including a unique identifier is present in the payment card, as issued by an issuer of the payment card of the user. After the capture, the unique identifier is appended to a payment transaction request. The payment transaction request and the unique identifier are sent to an acquirer server of the merchant. The payment transaction request also includes a payment amount corresponding to a purchase of the user. The acquirer accesses the merchant identifier upon receipt of the payment transaction request. Further, the acquirer accesses the loyalty program ruleset using the merchant identifier data and the unique identifier data.

The loyalty program ruleset is used for updating the payment amount. The payment amount is updated by mapping the payment amount into a loyalty point data. After the mapping, a redeemability of a total redeemable loyalty points from the loyalty point data is determined. The redeemability is determined based on a historical data of payment transactions of the user for purchasing from the merchant and an availability of a loyalty point data earned by the user corresponding to the purchasing. After determining the redeemability, the acquirer verifies whether the total redeemable loyalty points exceed a pre-defined number of loyalty points. The pre-defined number of points is determined based on the loyalty program ruleset. The redeemable loyalty points is deducted from the total redeemable loyalty points based on the verification. The payment amount is adjusted based on the redeemable loyalty points.

After updating the payment amount, the payment transaction request is updated. The updated payment transaction request for a payment transaction of the updated payment amount is sent to the issuer via a payment network. When an approval for the payment transaction is made, loyalty reward points for the user are determined. The loyalty reward points is determined using the loyalty program ruleset. Further, the loyalty summary is accessed using the merchant identifier and the unique identifier. The loyalty summary is updated based on the loyalty reward points. The updated loyalty summary is notified to the merchant. The merchant may further notify the updated loyalty summary to the user.

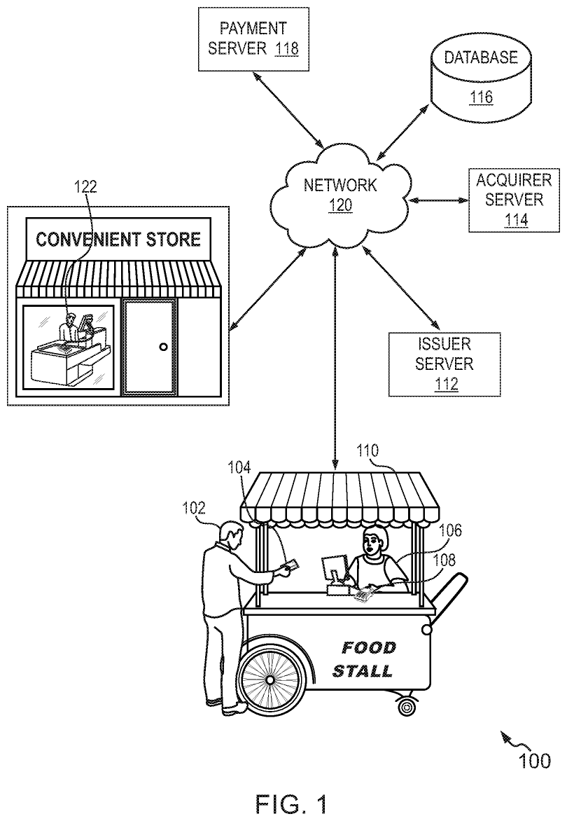

Thus, the loyalty program ruleset is created for providing the loyalty program by the merchant to the user in a feasible and affordable manner to the merchant. The merchant provides the loyalty program to the user, without having the need to issue any additional physical loyalty card. The loyalty program ruleset is also used for providing a loyalty reward point to the user after successful payment transaction for a purchase from the merchant. The generation of the loyalty program ruleset and execution of the payment transaction based on the loyalty program, are further explained in detail with reference to FIGS. 1 to 14.

FIG. 1 illustrates an example representation of an environment 100 related to at least some example embodiments of the present disclosure. The environment 100 is depicted to include a merchant 106 with a merchant terminal 108. The merchant 106 runs a food stall, such as a food stall 110. In an example embodiment, the merchant 106 registers for a loyalty program to an acquirer server 114 associated with the merchant 106. The acquirer server 114 is associated with a financial institution normally called as a “merchant bank” or an “acquiring bank” or an “acquirer bank” or simply an “acquirer”, in which the merchant 106 or the service provider entities may have an account. In an example embodiment, the merchant 106 performs the registration using the merchant terminal 108. The merchant terminal 108 may be associated with a device such as, but not limited to, a computer, a laptop, a mobile device or any computing device capable of performing the registration.

The merchant terminal 108 communicates with the acquirer server 114 via a network 120. The network 120 may include wired networks, wireless networks and combinations thereof. Some non-limiting examples of the wired networks may include Ethernet, local area networks (LANs), fiber-optic networks, and the like. Some non-limiting examples of the wireless networks may include cellular networks like GSM/3G/4G/5G/LTE/CDMA networks, wireless LANs, Bluetooth, Wi-Fi or Zigbee networks, and the like. An example of the combination of wired and wireless networks may include the Internet.

The acquirer server 114 receives a merchant data upon registration of the merchant 106. After receiving the merchant data, the acquirer server 114 assigns a merchant identifier for the merchant 106. The merchant data is stored in a database, such as a database 116 shown in FIG. 1. In one example embodiment, the database 116 may be associated with the acquirer server 114. In another example embodiment, the database 116 may be embodied in the acquirer server 114. The acquirer server 114 creates the loyalty program using a loyalty program ruleset. In an example embodiment, the loyalty program ruleset is generated based on a loyalty computation function. The loyalty computation function is determined by the acquirer server 114 using one or more loyalty computation parameters and one or more loyalty redemption parameters. After the creation of the loyalty program, a loyalty summary for the loyalty program is generated. The loyalty program ruleset and the loyalty summary are stored in the database 116. The loyalty program created by the acquirer server 114 differs from one merchant to another merchant. For instance, the loyalty program of the merchant 106 differs from a loyalty program of another merchant, such as a merchant 122 who runs a convenient store. The merchant 106 provides the loyalty program to users, such as a user 102, when the user 102 visits the merchant 106.

In an illustrative example scenario, the user 102 visits the merchant 106 for purchasing food items. The user 102 is associated with a payment card, such as a payment card 104 shown in FIG. 1. Some examples of the payment card 104 include a credit card, a debit card, or any bank card of the user 102. The payment card 104 includes a unique identifier that is issued by an issuer server 112 of the user 102. The issuer server 112 is associated with a financial institution normally called as an “issuer bank” or “issuing bank” or simply “issuer”, in which the user 102 may have an account, which issues one or more payment cards, such as a credit card or a debit card. In an example embodiment, the unique identifier data including the unique identifier resides in a secure chip (not shown in FIG. 1) that is embedded in the payment card 104.

After completing the purchase, the user 102 provides the payment card 104 to the merchant 106. The merchant 106 swipes the payment card 104 at a merchant terminal 108 for processing a payment transaction of the purchased items. After swiping the payment card 104, the merchant 106 enters a payment amount for the payment transaction at the merchant terminal 108. For instance, the merchant 106 enters the payment amount as Rs 500/− at the merchant terminal 108. When the payment card 104 is swiped, the merchant terminal 108 captures the unique identifier from the payment card 104. The merchant terminal 108 appends the unique identifier to a payment transaction request for the payment transaction.

The merchant terminal 108 sends the payment transaction request that includes the unique identifier and the payment amount to the acquirer server 114. The acquirer server 114 authorizes the payment transaction request. After successful authorization of the payment transaction request, the acquirer server 114 accesses the merchant identifier associated with the merchant 106. Further, the acquirer server 114 accesses the loyalty program ruleset from the database 116. The loyalty program ruleset is accessed using the merchant identifier and the unique identifier.

After accessing the loyalty program ruleset, the payment amount (i.e., Rs 500/−) is updated using the loyalty program ruleset. In one example embodiment, the payment amount is mapped into a loyalty point data. In order to modify the loyalty point data, a redeemability of a total redeemable loyalty points is determined. In one illustrative example scenario, the user 102 repeatedly visits the merchant 106 for purchasing and performs payment transactions to the merchant 106 for the purchases. In such scenario, a historical data of the payment transactions of the user 102 exists in the database 116 and there is availability of loyalty points earned by the user 102 corresponding to the purchases. The historical data and the earned loyalty points are used for determining the redeemability. Further, the total redeemable loyalty points is compared with a pre-defined number of loyalty points to determine redeemable loyalty points. The pre-defined number of loyalty points is determined based the loyalty program ruleset. The redeemable loyalty points is deducted from the total redeemable loyalty points based on the pre-defined number of loyalty points. Further, the payment transaction request is updated based on the updated payment amount. The acquirer server 114 sends the updated payment transaction request to the issuer server 112 via a payment server 118.

After receiving an approval for the payment transaction, the acquirer server 114 determines loyalty reward points for the user 102. The loyalty reward points are determined using the loyalty program ruleset. The loyalty reward point is updated in the loyalty summary. The loyalty summary is accessed from the database 116 using the merchant identifier and the unique identifier. The updated loyalty summary is notified to the merchant 106. The merchant 106 may further notify the updated loyalty summary to the user 102.

In another example scenario, if the user 102 visits the merchant 106 for the first time then there is no redeemable loyalty point for the user 102. In such case, the payment transaction request is not updated. For instance, the user 102 purchases for Rs 2000/− from the merchant 106. The payment transaction request for the payment transaction of Rs 2000/− is sent to the issuer server 112. A loyalty reward point is determined for the user 102 using the loyalty program ruleset. For instance, the loyalty reward point earned by the user 102 for the payment transaction of Rs 2000/− is (2000*0.05)=100 loyalty reward point. The loyalty reward point is stored in the loyalty summary using the merchant identifier and the unique identifier.

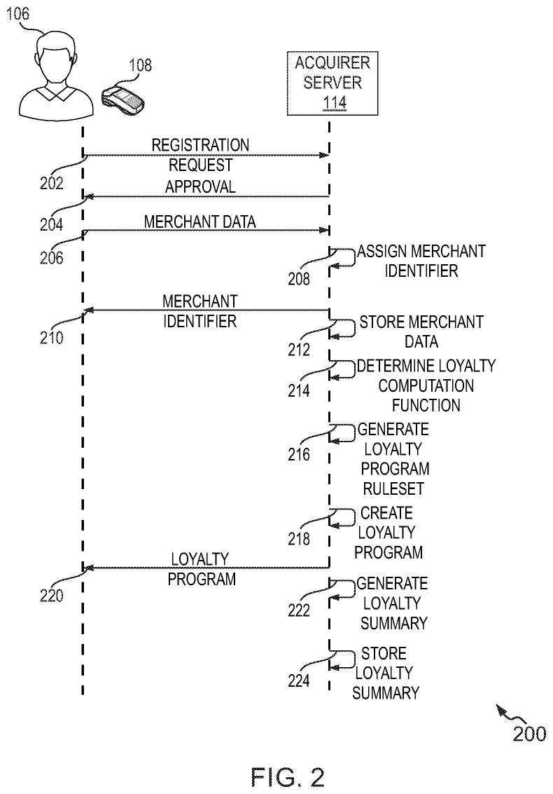

Some non-exhaustive example embodiments of providing the loyalty program and performing the payment transaction using the loyalty program, are described with reference to FIGS. 2 to 14.

Referring now to FIG. 2, a sequence flow diagram 200 of creating the loyalty program for the merchant 106 using the loyalty program ruleset, is represented in accordance with an example embodiment of the present disclosure. In an example embodiment, a registration of the merchant 106 for the loyalty program is performed using the merchant terminal 108.

At 202, the merchant terminal 108 sends a registration request to the acquirer server 114 for the registration. At 204, the acquirer server 114 sends an approval for the registration. The merchant 106 provides a merchant data in the merchant terminal 108 after receiving the approval. The merchant data includes a merchant name, a merchant category code, a merchant brand name, a merchant address, a contact number of the merchant and a payment account of the merchant.

At 206, the merchant terminal 108 sends the merchant data to the acquirer server 114. At 208, the acquirer server 114 assigns a merchant identifier for the merchant 106 upon receipt of the merchant data. At 210, the merchant identifier is notified to the merchant 106. At 212, the acquirer server 114 stores the merchant data in a database, such as the database 116 using the merchant identifier. The database 116 is described with reference to FIG. 1.

At 214, the acquirer server 114 determines at least one loyalty computation function using one or more loyalty calculation parameters and one or more loyalty redemption parameters. At 216, the acquirer server 114 generates the loyalty program ruleset based on the loyalty computation function. At 218, the acquirer server 114 creates the loyalty program for the merchant 106 using the loyalty program ruleset. At 220, the acquirer server 114 provides the loyalty program to the merchant 106.

At 222, the acquirer server 114 generates a loyalty summary for the loyalty program. At 224, the acquirer server 114 stores the loyalty summary in the database 116. The loyalty summary is maintained for each user of the merchant 106, and it can start with either Zero or a default number of loyalty points. The loyalty summary remains empty until loyalty reward points are earned by a user, i.e., the user 102 upon approval of a payment transaction of the user 102 by the issuer server 112. The loyalty summary is thereafter updated with the loyalty reward points earned or redeemed by the user 102.

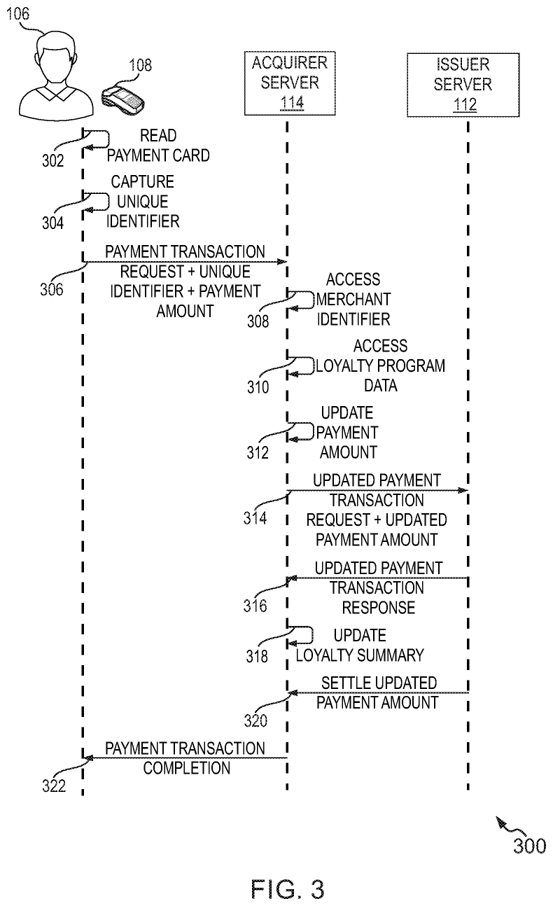

After providing the loyalty program to the user 102 by the merchant 106, the user 102 uses the loyalty program for purchasing from the merchant 106. A payment transaction is performed based on the loyalty program, which is further described with reference to FIG. 3.

Referring now to FIG. 3, a sequence flow diagram 300 depicting a process flow of a payment transaction of a purchase item of the user 102 using the loyalty program of the merchant 106 is represented, in accordance with an example embodiment of the present disclosure. In an illustrative example scenario, the merchant 106 enters a payment amount, e.g., 500/− for the payment transaction at the merchant terminal 108. The merchant 106 swipes the payment card 104 at the merchant terminal 108 for processing the payment transaction.

At 302, the merchant terminal 108 reads the payment card 104. At 304, the merchant terminal 108 captures the unique identifier from the payment card 104. At 306, the merchant terminal 108 sends a payment transaction request and the unique identifier to the acquirer server 114 for a payment transaction of the purchase items. The payment transaction request also includes the payment amount. The acquirer server 114 authorizes the payment transaction request.

At 308, the acquirer server 114 accesses the merchant identifier of the merchant 106 upon successful authorization of the merchant 106. At 310, the acquirer server 114 accesses a loyalty program ruleset using the merchant identifier and the unique identifier. The loyalty program ruleset is accessed from the database 116 shown in FIG. 1. As explained with reference to FIG. 1, the loyalty program ruleset is used for creation of a loyalty program for the merchant 106. The merchant 106 provides the loyalty program to users, such as the user 102.

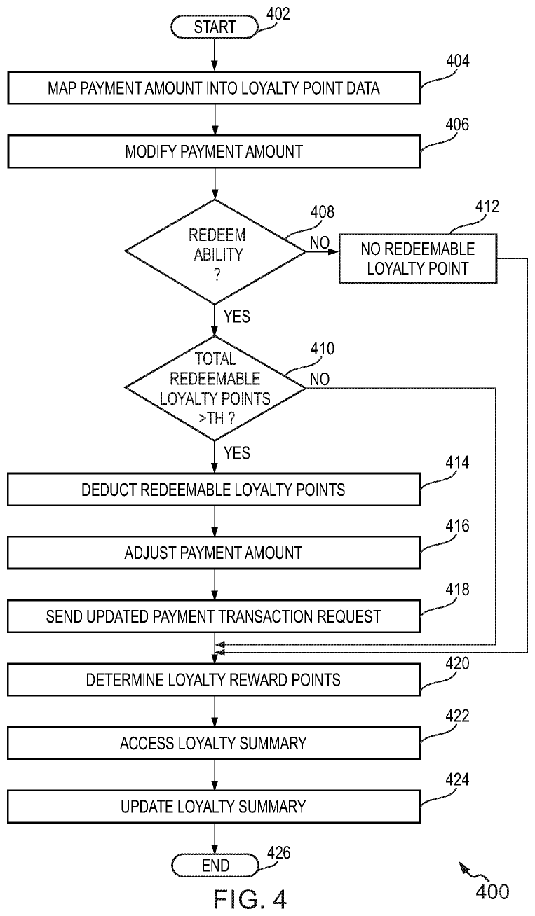

At 312, the acquirer server 114 updates the payment amount using the loyalty program ruleset. The payment amount is updated by mapping the payment amount into a loyalty point data, which is described further in FIG. 4. For example, a payment amount of Rs 500/− is mapped into 500 loyalty points using the loyalty program ruleset. The 500 loyalty points are modified if there is an existence of a historical data for payment transactions of the user 102 and an availability of loyalty points, say 300 points earned by the user 102. The historical data and the earned loyalty points are used to determine a redeemability of a total redeemable loyalty points from the loyalty point data (i.e., 500 loyalty points). The 500 loyalty points are compared with a pre-defined number of loyalty points, e.g., 50 loyalty points, which are determined based on the loyalty program ruleset. A redeemable loyalty point is deducted from the total redeemable loyalty points, i.e., 300−50=250 redeemable loyalty points. After the deduction, the payment amount is adjusted as Rs (500−250)/−=Rs 250/−.

At 314, the acquirer server 114 sends an updated payment transaction request for the updated payment amount to the issuer server 112. The updated payment transaction request is sent to the issuer server 112 via the payment server 118 using the network 120 (not shown in FIG. 2). The issuer server 112 validates the updated payment amount. In one illustrative example scenario, the user 102 visits the merchant 106 for the first time. There is no historical data of the payment transactions corresponding to the user 102, in some cases. If there is no historical data, then the user 102 has not earned any loyalty points. In such scenario, the payment transaction request for the payment amount (i.e., Rs. 500/−) is sent to the issuer server 112.

At 316, the acquirer server 114 receives the updated payment transaction response from the issuer server 112 via the payment server 118. The updated payment transaction response is received from the issuer server 112 via the payment server 118.

At 318, the loyalty summary is updated by the acquirer server 114 based on the updated payment amount. For example, if a user is transacting for Rs.1000 and Rs. 250 worth of loyalty is already present for the user, so the payment request is updated to Rs. 750. Once this request is approved by issuer server 112, the acquirer server 114 receives the updated payment transaction response for Rs. 750. Upon receiving the response, the acquirer server 114 will assess loyalty points for the transaction of Rs. 750, and update the royalty summary.

At 320, the updated payment amount is settled between the issuer server 112 and the acquirer server 114 via the payment server 118. At 322, the acquirer server 114 sends a notification on completion of the payment transaction to the merchant 106.

Further, upon receipt of an approval for the payment transaction, a loyalty reward point data for the user 102 is determined using the loyalty program ruleset, which is further explained next with reference to FIG. 4.

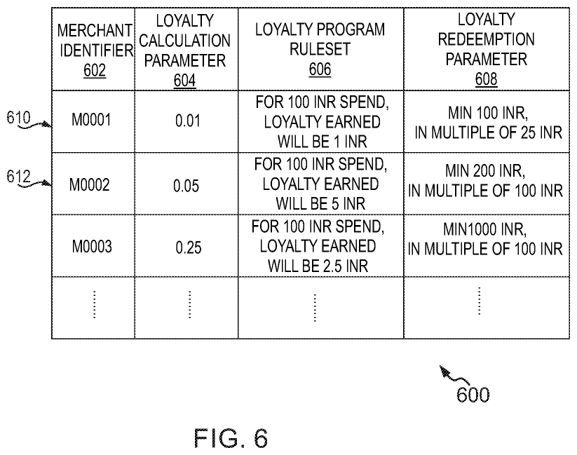

Referring now to FIG. 4, a flow chart 400 of determining loyalty reward points for the user 102 based on the loyalty program ruleset is shown, in accordance with an example embodiment of the present disclosure. In an illustrative example scenario, the acquirer server 114 receives a payment transaction request from the merchant terminal 108. The payment transaction request includes a payment amount, such as 500/− and the unique identifier of the user 102. As mentioned earlier with reference to FIG. 3, the acquirer server 114 accesses the loyalty program ruleset from the database 116 using the merchant identifier and the unique identifier. The storage of the loyalty program ruleset in the database 116 is further explained with reference to FIG. 6. The flow chart 400 starts at step 402.

At step 404, the acquirer server 114 maps the payment amount into a loyalty point data using the loyalty program ruleset. The payment amount of 500/− is mapped into loyalty point based on the loyalty program ruleset. For instance, the payment amount 500/− is mapped into 500 loyalty points. At step 406, the acquirer server 114 modifies the payment amount based on the mapping. Here, the loyalty program ruleset is for each Rs 100/−, 1 loyalty point is equivalent to Rs 5/− and so, 500 loyalty point is modified based on factor of 5/100=0.05 (refer FIG. 6). That is, 500*0.05=25 loyalty points.

At step 408, the acquirer server 114 determines a redeemability of a total redeemable loyalty points from the loyalty points. The redeemability is determined based on a historical data of payment transactions of the user 102 for purchasing from the merchant 106 and an availability of loyalty points earned by the user 102 corresponding to the purchasing. For example, the user 102 has repeated visits to the merchant 106 for purchasing. In such case, the user 102 has performed payment transactions to the merchant 106 for the purchase and there is availability of 200 loyalty points earned by the user 102 based on the purchase. Then, the total redeemable loyalty points=25+200=225. After determining the redeemability, proceed to step 410. In case, there is no redeemability, then proceed to step 412.

At step 410, the acquirer server 114 verifies whether the total redeemable loyalty points exceed a pre-defined number of loyalty point. The pre-defined number of loyalty points are determined based on the loyalty program ruleset. For example, the 225 loyalty point is compared with a threshold loyalty points=100. The threshold loyalty point is determined based on the ruleset “MIN 200 INR, in multiple of 100 loyalty points” (refer row 612 in FIG. 6).

At step 412, the acquirer server 114 determines no redeemable loyalty point. If the user 102 visits the merchant 106 for the first time, then the user 102 has not earned any loyalty points. In such case, continue to step 420.

At step 414, the acquirer server 114 deducts redeemable loyalty points, i.e., 200 from the total redeemable loyalty points, i.e., 225. For instance, out of 225 redeemable loyalty points, 200 redeemable loyalty points are deducted as 225>100 loyalty points. At step 416, the payment amount is adjusted based on the deduction. The payment amount 500/− is adjusted as Rs 500−200=Rs 300/−. In case, the redeemable loyalty point is less than the pre-defined number of loyalty points, then go to step 420.

At step 418, the acquirer server 114 sends an updated payment transaction request for the updated payment amount, i.e., Rs 300/− to the issuer server 112. The issuer server 112 provides an approval for a payment transaction of the updated payment amount.

At step 420, the acquirer server 114 determines loyalty reward points upon approval of the payment transaction. The loyalty reward points are determined using the loyalty program ruleset. For instance, the loyalty reward points=300*0.05=15 loyalty reward points. A total loyalty reward point for the user 102 is obtained by adding the loyalty reward points, i.e., 15 with remaining loyalty reward points, i.e., 25. Thus, the total loyalty reward points=15+25=40 loyalty reward points.

At step 422, the acquirer server 114 accesses the loyalty summary for the loyalty program using the merchant identifier and the unique identifier. At step 424, the acquirer server 114, updates the loyalty summary based on the loyalty reward points, i.e., 40 loyalty reward points. In case, there is no redeemability of loyalty point, then upon approval of the payment transaction for Rs 500/−, the total loyalty reward point is calculated as 500*0.05=25. The total loyalty reward points of 25 are updated in the loyalty summary.

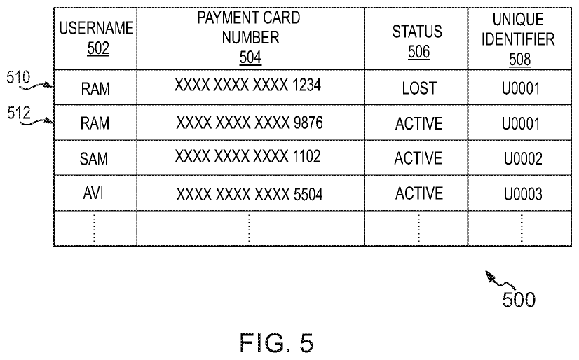

As mentioned in FIG. 1, the issuer server 112 issues the unique identifier for the user 102. The unique identifier is stored in the payment card 104. In some cases, it may happen that the payment card 104 may be lost. In some other cases, the payment card 104 may be upgraded. In such cases, the unique identifier is restored in a new payment card or an upgraded payment card by the issuer server 112. The unique identifier is stored and maintained at the issuer server 112, which is shown and described with reference to FIG. 5.

Referring now to FIG. 5, a table 500 representing a storage of unique identifiers of users (e.g., the user 102) at the issuer server 112 is shown, in accordance with an example embodiment of the present disclosure. As seen in FIG. 5, the table 500 includes information of users, such as usernames, payment cards of the users, status of the payment cards, such as active or lost and unique identifiers that are stored in respective payment card. It shall be noted that the table 500 shown in FIG. 5 is only provided for purposes of explanation and may not be considered as limiting the scope of the disclosure.

The table 500 includes columns representing a username field 502, a payment card number field 504, a status field 506 and a unique identifier field 508. As an example, a row 510 depicts a user named ‘SAMI’ with a payment card number, such as ‘XXXX-XXXX-XXXX-1234’ that is in a ‘LOST’ status. The unique identifier stored in the payment card is depicted as ‘U0001’. The status indicates that the user ‘SAMI’ has lost the current payment card. Although, the payment card is lost, the unique identifier is restored in a new payment card. For instance, in row 512 the unique identifier ‘U0001’ is restored in a payment card with a payment card number ‘XXXX-XXXX-XXXX-9876’. Likewise, each row represents each user uniquely associated with each unique identifier.

As mentioned earlier in FIG. 1, a loyalty program created for a merchant, such as the merchant 106 differs from another merchant, such as the merchant 122. Further, the loyalty program is created based on a loyalty program ruleset. Thus, the loyalty program ruleset differs from different merchants. The difference in loyalty program ruleset for different merchants, is shown with reference to FIG. 6.

Referring now to FIG. 6, a table 600 representing the loyalty program ruleset for generating the loyalty program of the merchant 106 is shown, in accordance with an example embodiment of the present disclosure. The table 600 includes columns representing a merchant identifier field 602, a loyalty calculation parameter field 604, a loyalty program ruleset field 606 and a loyalty redemption parameter field 608. It shall be noted that the table 600 may include multiple such tables and each table may include more or less rows and columns than those depicted in FIG. 6. The table 600 shown in FIG. 6 is only provided for purposes of explanation and may not be considered as limiting the scope of the disclosure.

As shown in FIG. 6, the table 600 includes different loyalty program rulesets for different merchants. Each loyalty program ruleset is stored using corresponding merchant identifier of each merchant. For instance, a merchant identifier assigned to the merchant 106 is depicted as ‘M0001’ and a merchant identifier assigned to the merchant 122 is depicted as ‘M0002’. As an example, in a row 610 a loyalty program ruleset ‘FOR 100 INR SPENT, LOYALTY POINT EARNED=1’ for the merchant 106 is stored using the merchant identifier ‘M0001’ under the loyalty program ruleset field 606. The loyalty program ruleset for the merchant 106 is generated using a loyalty calculation parameter (i.e., ‘0.01’) and a loyalty redemption parameter (i.e., ‘MIN 100 INR, IN MULTIPLE OF 25 INR’). The loyalty calculation parameter and the loyalty redemption parameter are in the row 610 under the loyalty calculation parameter field 604 and the loyalty redemption parameter field 608 respectively.

In a similar manner, a loyalty program ruleset for the merchant 122 is stored using the merchant identifier ‘M0002’. As an example, a row 612 depicts the merchant identifier ‘M0002’ with a loyalty program ruleset ‘FOR 100 INR SPENT, LOYALTY POINT EARNED=5’ under the loyalty program ruleset field 606. The loyalty program ruleset is generated using a loyalty calculation parameter (i.e., ‘0.05’) and a loyalty redemption parameter (i.e., ‘MIN 200 INR, IN MULTIPLE OF 100 INR’).

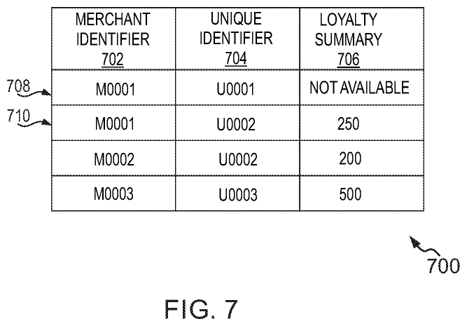

In an embodiment, a loyalty summary is generated for a loyalty program of a merchant, such as the merchant 106. The loyalty summary is stored in the database 116 using the merchant identifier and the unique identifier. Furthermore, the loyalty summary is updated based on a loyalty rewards. The loyalty summary is described with reference to FIG. 7.

Referring now to FIG. 7, a table 700 representing a loyalty summary for the loyalty program of merchants, such as the merchant 106 is shown, in accordance with an example embodiment of the present disclosure. As shown in FIG. 7, the table 700 includes columns representing a merchant identifier field 702, a unique identifier field 704 and a loyalty summary field 706. It shall be noted that the table 700 may include multiple such tables and each table may include more or less rows and columns than those depicted in FIG. 7. The table 700 shown in FIG. 7 is only provided for purposes of explanation and may not be considered as limiting the scope of the disclosure.

In an example scenario, a user, such as the user 102 visits a merchant, such as the merchant 106 for the first time. In such scenario, the user 102 may not have earned any loyalty points and loyalty summary is null. As an example, a row 708 depicts a merchant identifier ‘M0001’ of the merchant 106, a unique identifier ‘U0001’ of the user 102 and a loyalty summary depicted as ‘NOT AVAILABLE’ under the loyalty summary field 706. In another example scenario, the user 102 repeatedly visits the merchant 106 and performs a payment transaction for a purchase. In such scenario, the user 102 earns loyalty reward points upon receipt of an approval for the payment transaction. The loyalty reward points are updated in the loyalty summary field 706. For instance, a row 710 depicts the merchant identifier ‘M0001’ with a unique identifier ‘U0002’ of the user 102 and a loyalty summary with loyalty reward points of ‘250 INR’.

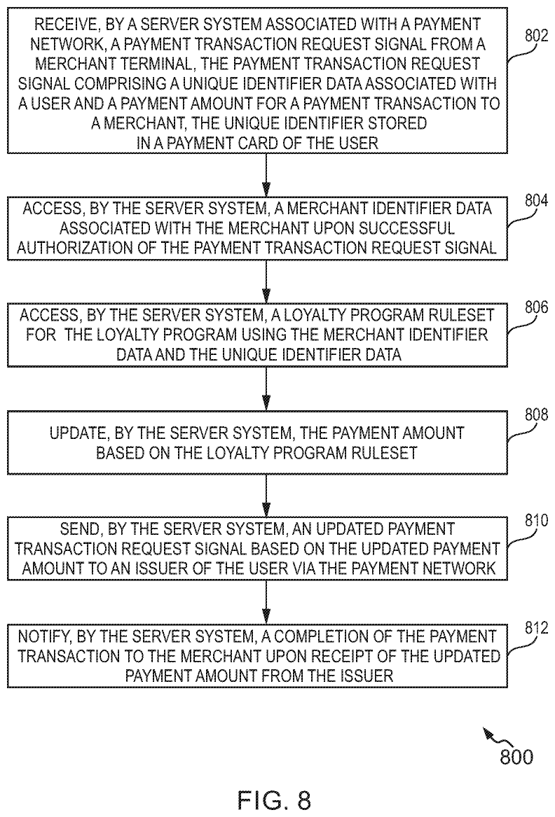

FIG. 8 illustrates a flow diagram depicting a method 800 for performing a payment transaction using a loyalty program of a merchant 106, in accordance with an example embodiment of the present disclosure. The method 800 depicted in the flow diagram may be executed by, for example, the acquirer server 114. Operations of the method 800, and combinations of operation in the method 800, may be implemented by, for example, hardware, firmware, a processor, circuitry and/or a different device associated with the execution of software that includes one or more computer program instructions. The method 800 starts at operation 802.

At operation 802, the method 800 includes receiving, by a server system associated with a payment network, a payment transaction request signal from a merchant terminal 108. The payment transaction request signal includes a unique identifier data associated with a user 102 and a payment amount for a payment transaction to a merchant 106. The unique identifier is stored in a payment card 104 of the user 102. In an example embodiment, the unique identifier is issued by an issuer of the user 102. The unique identifier is captured when the payment card 104 is swiped at a merchant terminal 108 by the merchant 106. The unique identifier is appended in the payment transaction request (refer FIG. 3).

At operation 804, the method 800 includes accessing, by the server system, a merchant identifier data associated with the merchant 106 upon successful authorization of the payment transaction request signal. In an example embodiment, the merchant 106 registers for the loyalty program. In the registration, the merchant 106 provides merchant data that includes a merchant name, a merchant category code, a merchant brand name, a merchant address, a contact number of the merchant 106 and a payment account of the merchant 106. The merchant identifier is assigned to the merchant 106 upon receipt of the merchant data. The merchant data is stored using the merchant identifier (refer FIG. 2).

At operation 806, the method 800 includes accessing, by the server system, a loyalty program ruleset for the loyalty program using the merchant identifier data and the unique identifier data. In an example embodiment, the loyalty program ruleset is generated based on a loyalty computation function. The loyalty computation function is determined using a loyalty calculation parameter and a loyalty redemption parameter (refer FIG. 2). After generating the loyalty program, a loyalty summary data is generated for the loyalty program. The loyalty summary data is stored in the database 116 using the merchant identifier data and the unique identifier data.

At operation 808, the method 800 includes updating, by the server system, the payment amount based on the loyalty program ruleset. In an example embodiment, the payment amount is updated by mapping the payment amount into a loyalty point data using the loyalty program ruleset. The payment amount is modified based on the mapping. After the modification, a redeemability of a total redeemable loyalty points from the loyalty point data is determined (refer FIG. 4). The redeemability is determined based on a historical data of payment transactions of the user 102 for purchasing from the merchant 106 and an availability of loyalty points earned by the user 102 corresponding to the purchasing. After determining the redeemability, verify whether the total redeemable loyalty points exceed a pre-defined number of loyalty points. The pre-defined number of loyalty points is determined based on the loyalty program ruleset (refer FIG. 6). A redeemable loyalty points is deducted from the total redeemable loyalty point based on the verification. The payment amount is adjusted based on the deduction.

At operation 810, the method 800 includes sending, by the server system, an updated payment transaction request signal based on the updated payment amount to an issuer of the user 102 via the payment network. A loyalty reward point is determined using the loyalty program ruleset upon receipt of an approval for the payment transaction. The loyalty reward points are updated in the loyalty summary data (refer FIG. 4).

At operation 812, the method 800 includes notifying, by the server system, a completion of the payment transaction upon receipt of the updated payment amount from the issuer.

The sequence of operations of the method 800 need not to be necessarily executed in the same order as they are presented. Further, one or more operations may be grouped together and performed in form of a single step, or one operation may have several sub-steps that may be performed in parallel or in sequential manner.

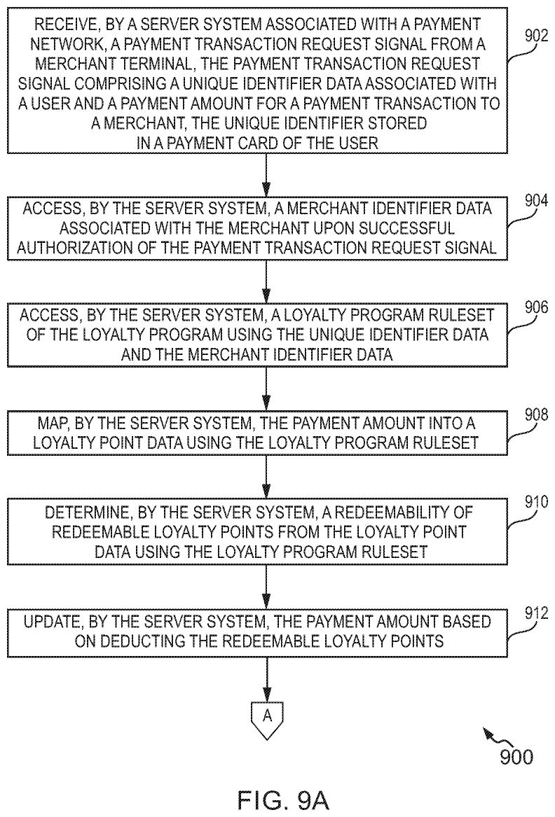

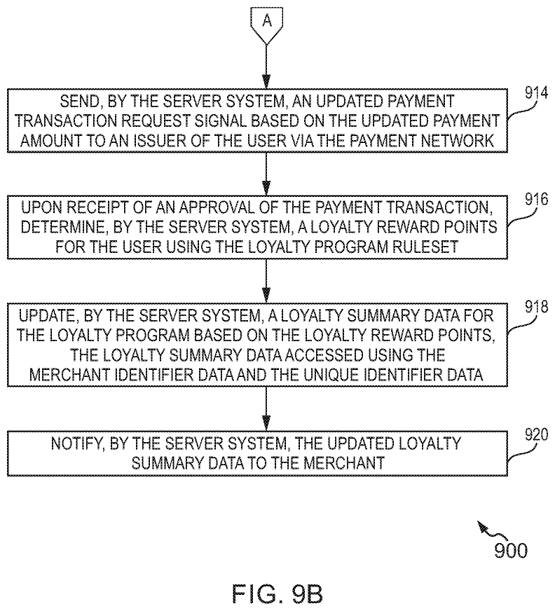

FIGS. 9A and 9B, collectively, illustrate a flow diagram depicting a method 900 for performing the payment transaction using the loyalty program, in accordance with another example embodiment of the present disclosure. The method 900 depicted in the flow diagram may be executed by, for example, the acquirer server 114. Operations of the method 900, and combinations of operation in the method 900, may be implemented by, for example, hardware, firmware, a processor, circuitry and/or a different device associated with the execution of software that includes one or more computer program instructions. The method 900 starts at operation 902.

At operation 902, the method 900 includes receiving, by a server system associated with a payment network, a payment transaction request signal from a merchant terminal 108, the payment transaction request signal including a unique identifier data associated with a user 102 and a payment amount for a payment transaction to a merchant 106. The unique identifier is stored in a payment card 104 of the user 102.

At operation 904, the method 900 includes accessing, by the server system, a merchant identifier data associated with the merchant 106 upon successful authorization of the payment transaction request signal.

At operation 906, the method 900 includes accessing, by the server system, a loyalty program ruleset of the loyalty program using the unique identifier data and the merchant identifier data. The operations 902-906 are similar to operations 802-806 in method 800. The operations 902-906 are already described with reference to FIG. 8 and thus not described herein for sake of brevity.

At operation 908, the method 900 includes mapping, by the server system, the payment amount into a loyalty point data using the loyalty program ruleset. The payment amount is modified based on the mapping. For example, a payment amount of Rs 500 is mapped into 500 loyalty point data. The 500 loyalty point is modified as 500*0.05=25 using the loyalty program ruleset.

At operation 910, the method 900 includes determining, by the server system, a redeemability of a total redeemable loyalty points using the loyalty program ruleset. The redeemability is determined based on a historical data of payment transactions of the user 102 for purchasing from the merchant 106 and an availability of loyalty points earned by the user 102 corresponding to the purchasing. For instance, if the user 102 has earned 200 loyalty points, then the total redeemable loyalty points=200+25=225.

At operation 912, the method 900 includes updating, by the server system, the payment amount based on deducting the redeemable loyalty point data. In an example embodiment, the payment amount is updated by verifying whether the total redeemable loyalty points exceed a pre-defined number of loyalty points. For instance, the total redeemable loyalty points=225 are compared with the pre-defined number of loyalty points, i.e., 225>25. The redeemable loyalty points, i.e., 200 are deducted from the total redeemable loyalty points, i.e., 225. The payment amount of Rs 500/− is adjusted as 500−200=Rs 300/−.

At operation 914, the method 900 includes sending, by the server system, an updated payment transaction request signal based on the updated payment amount to an issuer of the user 102 via the payment network.

At operation 916, the method 900 includes upon receipt of an approval of the payment transaction, determining, by the server system, loyalty reward points for the user 102 using the loyalty program ruleset. For instance, the loyalty reward points for Rs 300/− are calculated as 300*0.05=15 loyalty reward points, which are added to remaining loyalty reward points, i.e., 25 loyalty points. The total loyalty reward points=15+25=40 loyalty reward points.

At operation 918, the method 900 includes updating, by the server system, a loyalty summary data for the loyalty program based on the loyalty reward points, the loyalty summary data accessed using the merchant identifier data and the unique identifier data. For instance, the loyalty summary data is updated with the total loyalty reward points (i.e., 40 loyalty reward points).

At operation 920, the method 900 includes notifying, by the server system, the updated loyalty summary data to the merchant 106.

The sequence of operations of the method 900 need not to be necessarily executed in the same order as it is presented. Further, one or more operations may be grouped together and performed in form of a single step, or one operation may have several sub-steps that may be performed in parallel or in sequential manner.

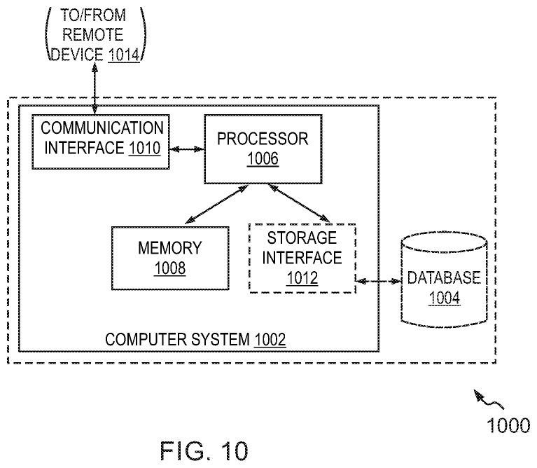

FIG. 10 is simplified block diagram of a server system 1000 for providing a loyalty program to a merchant, such as the merchant 106, in accordance with an embodiment of the present disclosure. The server system 1000 is an example of a server, such as the acquirer server 114 shown and described with reference to FIG. 1. The server system 1000 includes a computer system 1002 and a database 1004. In an embodiment, the server system 1000 is integrated in the acquirer server 114. The computer system 1002 includes at least one processor 1006 configured to execute executable instructions for providing various features of the present disclosure. The executing instructions are stored in a memory 1008. The components of the computer system 1002 provided herein may not be exhaustive and that the computer system 1002 may include more or fewer components than those depicted in FIG. 10. Further, two or more components may be embodied in one single component, and/or one component may be configured using multiple sub-components to achieve the desired functionalities. Some components of the computer system 1002 may be configured using hardware elements, software elements, firmware elements and/or a combination thereof.

The processor 1006 is operatively coupled to a communication interface 1010 such that the computer system 1002 is capable of communicating with a remote device 1014 such as the merchant terminal 108, the acquirer server 114 or capable of communicating with any entity connected to the network 120 (shown in FIG. 1) or any constituents of the payment network. In an embodiment, the communication interface 1010 is configured to receive a payment transaction request signal from the merchant terminal 108. The payment transaction request includes a unique identifier data and a payment amount for a payment transaction to a merchant (e.g., the merchant 106). The unique identifier data is present in a payment card (e.g., the payment card 104) of a user (e.g., the user 102). The unique identifier is captured by a merchant terminal (merchant terminal 108). The communication may be achieved through API calls, without loss of generality.

In an embodiment, the processor 1006 accesses a merchant identifier data associated with the merchant 106. The merchant identifier data is accessed from the database 1004 upon successful authorization of the payment transaction request signal. Further, the processor 1006 uses the merchant identifier data and the unique identifier data for accessing a loyalty program ruleset for the loyalty program from the database 1004. The processor 1006 may also be operatively coupled to the database 1004. The database 1004 is any computer-operated hardware suitable for storing and retrieving data, such as, but not limited to, information of the user 102, the unique identifier, information of the merchant 106, the merchant identifier data, information related to the loyalty program ruleset, and transaction data generated as part of sales activities conducted over the bankcard network including data relating to merchants, payees, or customers, and purchases. The database 1004 may also store information related to a plurality of bank accounts of customers. Each user account data includes at least one of a cardholder name, a cardholder address, an account number, MPIN, and other account identifier. The database 1004 may also include instructions for settling transactions including merchant bank account information. The database 1004 may include multiple storage units such as hard disks and/or solid-state disks in a redundant array of inexpensive disks (RAID) configuration. The database 1004 may include a storage area network (SAN) and/or a network attached storage (NAS) system.

In some embodiments, the database 1004 is integrated within computer system 1002. For example, the computer system 1002 may include one or more hard disk drives as the database 1004. In other embodiments, the database 1004 is external to the computer system 1002 and may be accessed by the computer system 1002 using a storage interface 1012. The storage interface 1012 is any component capable of providing the processor 1006 with access to the database 1004. The storage interface 1012 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing processor 1006 with access to the database 1004.

The processor 1006 is configured to update the payment amount based on the loyalty program ruleset. The payment transaction request is updated based on the updated payment amount. The updated payment transaction request is sent to an issuer of the user 102, such as the issuer server 112 via the communication interface 1010 using a payment network, such as the network 120. The network 120 may be used as the payment network by the acquirer server 1100, the payment server 118 and the issuer server 112 as a payment interchange network. Examples of payment interchange network include, but not limited to, Mastercard® payment system interchange network. The communication interface 1010 is further configured to notify the merchant 106 a completion of the payment transaction upon receipt of the updated payment amount from the issuer server 112.

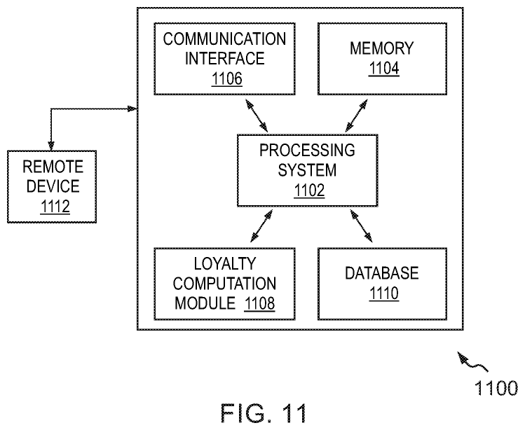

FIG. 11 is a simplified block diagram of an acquirer server 1100 for providing the loyalty program of the merchant 106, in accordance with an embodiment of the present disclosure. The acquirer server 1100 is an example of the acquirer server 114 of FIG. 1. The acquirer server 1100 includes a processing system 1102 operatively coupled to a memory 1104, a communication interface 1106, a loyalty computation module 1108 and a database 1110. The processing system 1102 is configured to extract programming instructions from a memory 1104 to provide various features of the present disclosure. Additionally, the memory 1104 stores instructions for creating the loyalty program of the merchant 106, that are executed by the processing system 1102. The components of the acquirer server 1100 provided herein may not be exhaustive and that the acquirer server 1100 may include more or fewer components than those depicted in FIG. 11. Further, two or more components may be embodied in one single component, and/or one component may be configured using multiple sub-components to achieve the desired functionalities. Some components of the acquirer server 1100 may be configured using hardware elements, software elements, firmware elements and/or a combination thereof.

In an example embodiment, the communication interface 1106 receives a registration request signal from a remote device 1112, such as the merchant terminal 108 for registering a merchant, i.e., the merchant 106 for a loyalty program. The communication interface 1106 further receives a merchant data upon registration of the merchant 106. The merchant data includes, but is not limited to, a merchant name, a merchant category code, a merchant brand name, a merchant address, a contact number of the merchant and a payment account of the merchant. After receiving the merchant data, the processing system 1102 assigns a merchant identifier for the merchant 106. The processing system 1102 stores the merchant data and the merchant identifier in the database 1110.

In an embodiment, the loyalty computation module 1108 is configured to determine at least one loyalty computation function using one or more loyalty calculation parameters and one or more loyalty redemption parameters. The loyalty computation module 1108 provides the loyalty computation function to the processing system 1102. The processing system 1102 generates a loyalty program ruleset using the loyalty computation function. The loyalty program ruleset is stored in the database 1110 (refer FIG. 6). Further, the processing system 1102 creates the loyalty program using the loyalty program ruleset. The loyalty program is notified to the merchant 106 by sending the loyalty program to the remote device 1112, i.e., the merchant terminal 108 via the communication interface 1106. After the creation of the loyalty program ruleset, the processing system 1102 creates a loyalty summary for the loyalty program. Initially, the loyalty summary is stored with no data in the database 1110.

Via the communication interface 1106, the processing system 1102 receives a payment transaction request from the merchant terminal 108. The payment transaction request includes a unique identifier data and a payment amount for a payment transaction to the merchant 106. The unique identifier data is associated with a user, i.e., the user 102 and is stored in a payment card, i.e., the payment card 104 of the user 102. The communication may be achieved through API calls, without loss of generality. After receiving the unique identifier data, the processing system 1102 accesses the merchant identifier data of the merchant 106 from the database 1110. Further, the processing system 1102 accesses a loyalty program ruleset from the database 1110 using the merchant identifier data and the unique identifier data. The processing system 1102 uses the loyalty program ruleset for mapping the payment amount into a loyalty point data.

After modifying the payment amount, the processing system 1102 determines a redeemability of a total redeemable loyalty points from the loyalty point data. The redeemability is determined based on an availability of historical data of payment transactions of the user 102 for purchasing from the merchant 106 and an availability of loyalty points earned by the user 102 corresponding to the purchasing. The processing system 1102 is further configured to verify whether the total redeemable loyalty points exceed a pre-defined number of loyalty points. The pre-defined number of loyalty points is determined using the loyalty program ruleset. The processing system 1102 deducts a redeemable loyalty points from the total redeemable loyalty points based on the verification.

Further, the communication interface 1106 receives an approval for the payment transaction from the issuer server 112. The communication interface 1106 provides the approval to the processing system 1102. The processing module 1102 determines loyalty reward points data for the user 102, upon receipt of the approval. The loyalty reward points are determined using the loyalty program ruleset. After determining the loyalty reward points, the processing system 1102 accesses the loyalty summary from the database 1110 using the merchant identifier data and the unique identifier data. The loyalty summary data is updated by the processing system 1102 based on the loyalty reward points. The updated loyalty summary data is notified to the merchant 106.

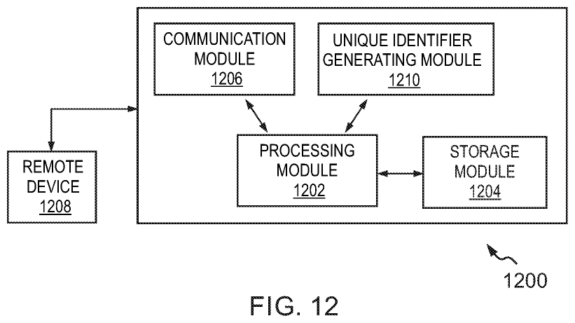

FIG. 12 is a simplified block diagram of an issuer server 1200, in accordance with an embodiment of the present disclosure. The issuer server 1200 is an example of the issuer server 112 of FIG. 1. The issuer server 1200 is associated with an issuer bank/issuer, in which a user (e.g., the user 102) may have a payment account, which provides a payment card 104 with a unique identifier for the user 102. The issuer server 1200 includes a processing module 1202 operatively coupled to a storage module 1204 and a communication module 1206. The components of the issuer server 1200 provided herein may not be exhaustive and that the issuer server 1200 may include more or fewer components than those depicted in FIG. 12. Further, two or more components may be embodied in one single component, and/or one component may be configured using multiple sub-components to achieve the desired functionalities. Some components of the issuer server 1200 may be configured using hardware elements, software elements, firmware elements and/or combination thereof.

The storage module 1204 is configured to store machine executable instructions to be accessed by the processing module 1202. Additionally, the storage module 1204 stores information related to, contact information of the user, bank account number, availability of funds in the account, payment card details, transaction details and/or the like. In an example embodiment, the unique identifier generating module 1210 is configured to issue the unique identifier data of the user 102. The unique identifier data is stored in the storage module 1204. The unique identifier generating module 1210 issues unique identifiers for users that are stored and maintained in the storage module 1204 (refer FIG. 5).

The processing module 1202 is configured to communicate with one or more remote devices such as a remote device 1208 using the communication module 1206 over a network, such as the network 120 of FIG. 1. The examples of the remote device 1208 include the payment server 118 or other computing systems of issuer and the network 120 and the like. The communication module 1206 is capable of facilitating such operative communication with the remote devices and cloud servers using API (Application Program Interface) calls. The processing module 1202 receives a payment card information, a payment transaction amount, a customer information and merchant information in remote device 1208 (i.e. the payment server 118) via the communication module 1206. The communication module 1206 is also configured to send an approval for a payment transaction to the acquirer server 1100.

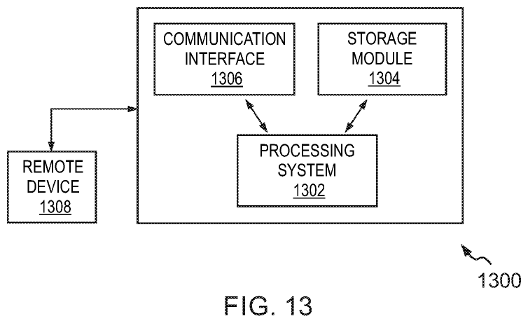

FIG. 13 is a simplified block diagram of a payment server 1300, in accordance with an embodiment of the present disclosure. The payment server 1300 is an example of a server (e.g., the payment server 118). The network 120 may be used as a payment network by the payment server 1300, the issuer server 1200 and the acquirer server 1100 as a payment interchange network. Examples of payment interchange network include, but not limited to, Mastercard® payment system interchange network. The payment server 1300 includes a processing system 1302 configured to extract programming instructions from a storage module 1304 for a payment transaction of the merchant 106. The processing system 1302 is communicably coupled with a communication interface 1306. The components of the payment server 1300 provided herein may not be exhaustive and that the payment server 1300 may include more or fewer components than those depicted in FIG. 13. Further, two or more components may be embodied in one single component, and/or one component may be configured using multiple sub-components to achieve the desired functionalities. Some components of the payment server 1300 may be configured using hardware elements, software elements, firmware elements and/or a combination thereof.

The communication interface 1306 is configured to receive a payment transaction request from a remote device 1308, such as the acquirer server 1100. The payment transaction request includes a unique identifier data associated with a payment card (i.e., the payment card 104) of a user (i.e., the user 102) and a payment amount for a payment transaction to a merchant (i.e., the merchant 106). The processing system 1302 transfers the payment transaction request to the remote device, such as the issuer server 1200 via the communication interface 1306. The communication may be achieved through API calls, without loss of generality. Further, the processing system 1302 receives the payment amount from the issuer server 1200, via the communication interface 1306. The communication interface 1306 is further configured to send the payment amount to the acquirer server 1100.

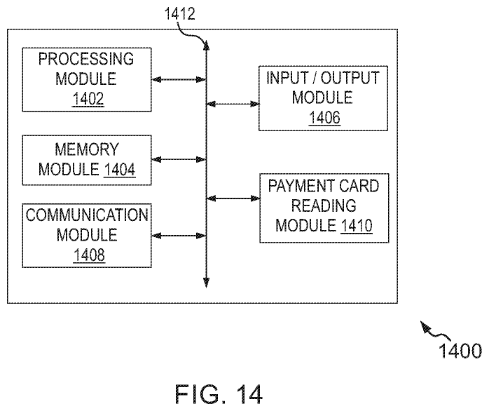

FIG. 14 shows a simplified block diagram of a merchant terminal 1400 capable of implementing the various embodiments of the present disclosure. The merchant terminal 1400 is an example of the merchant terminal 108. It should be understood that the merchant terminal 1400 as illustrated and hereinafter described is merely illustrative of one type of device and should not be taken to limit the scope of the embodiments. As such, it should be appreciated that at least some of the components described below in connection with the merchant terminal 1400 may be optional and thus in an example embodiment may include more, less or different components than those described in connection with the example embodiment of the FIG. 14. As such, among other examples, the merchant terminal 1400 could be any of an electronic device, for example, cellular phones, tablet computers, laptops, mobile computers, personal digital assistants (PDAs), mobile televisions, mobile digital assistants, or any combination of the aforementioned, and other types of communication or multimedia devices.

The illustrated merchant terminal 1400 includes a processing module 1402 (e.g., a signal processor, microprocessor, ASIC, or other control and processing logic circuitry) for performing such tasks as signal coding, data processing, input/output processing, and/or other functions. The illustrated merchant terminal 1400 also includes a memory module 1404 that stores executable instructions to be executed by the processing module 1402. Further, the merchant terminal 1400 also includes an input/output (I/O) module 1406, a communication module 1408 and a payment card reading module 1410. The components of the merchant terminal 1400 provided herein may not be exhaustive and that the merchant terminal 1400 may include more or fewer components than those depicted in FIG. 14. Further, two or more components may be embodied in one single component, and/or one component may be configured using multiple sub-components to achieve the desired functionalities. Some components of the merchant terminal 1400 may be configured using hardware elements, software elements, firmware elements and/or a combination thereof.

The payment card reading module 1410 is configured to read a payment card, i.e., the payment card 104 of a user, i.e., the user 102. When the payment card 104 is read, the payment card reading module 1410 extracts a unique identifier data in the payment card 104. In an example embodiment, the payment card reading module 1410 captures the unique identifier data from a secure chip stored in the payment card 104. The unique identifier data is provided to the processing module 1402. The processing module 1402 appends the unique identifier data to a payment transaction request for a payment transaction to a merchant, i.e., the merchant 106.

In an embodiment, the input/output module 1406 may include mechanisms configured to receive inputs from and provide outputs to a merchant, such as the merchant 106. To that effect, the I/O module 1406 may include at least one input interface and/or at least one output interface. Examples of the input interface may include, but are not limited to, a keypad, a touch screen, soft keys, a microphone, and the like. Examples of the output interface may include, but are not limited to, a display such as a light emitting diode display, a thin-film transistor (TFT) display, a liquid crystal display, an active-matrix organic light-emitting diode (AMOLED) display, a microphone, a speaker, a ringer, a vibrator, and the like. In an example embodiment, the I/O module 1406 is configured to receive a payment amount provided by the merchant 106. The payment amount is provided to the processing module 1402. Further, the processing module 1402 sends the payment transaction request with the unique identifier data and the payment amount to the issuer server 1200 via the communication module 1408. In an embodiment, the processing module 1402 is operatively coupled to the communication module 1408 such that the merchant terminal 1400 is capable of communicating with a server, such as the acquirer server 1100 (e.g., the acquirer server 114) providing the loyalty program to the merchant 106 or communicating with any entity within the network 120.

Moreover, the various components of the merchant terminal 1400, such as the processing module 1402, the memory module 1404, the I/O module 1406, the communication module 1408 and the payment card reading module 1410 may be configured to communicate with each other via or through a centralized circuitry 1412. The centralized circuit system 1412 may be various devices configured to, among other things, provide or enable communication among the components (1402-1410) of the merchant terminal 1400. In certain embodiments, the centralized circuit system 1412 may be a central printed circuit board (PCB) such as a motherboard, a main board, a system board, or a logic board. The centralized circuit system 1412 may also, or alternatively, include other printed circuit assemblies (PCAs) or communication channel media. In some embodiments, the centralized circuit system 1412 may include appropriate storage interfaces to facilitate communication among the components (1402-1410). Some examples of the storage interface may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing the merchant terminal 1400 with access to the data stored in a memory (not shown in FIG. 14).

Without limiting the scope of the present disclosure, the one or more example embodiments disclosed herein provide methods and systems for providing a loyalty program to a merchant. The loyalty program is provided to the merchant by an acquirer of the merchant. The loyalty program is created by the acquirer based on a loyalty program ruleset using a loyalty computation function. The loyalty computation function is determined by the acquirer using a loyalty calculation parameter and a loyalty redemption parameter. The loyalty calculation parameter and the loyalty redemption parameter correspond to the merchant. Thus, the loyalty program created is feasible, affordable and efficient to the merchant. Moreover, the merchant provides the loyalty program without issuing any additional physical cards, which is convenient for both the user and the merchant. The loyalty program is provided to a user through a unique identifier data that is stored in a payment card of the user. The unique identifier data remains immutable even when the payment card is upgraded or regenerated to a new payment card. Thus, the user can still use the loyalty program in a seamless manner.

The disclosed methods with reference to FIGS. 1 to 14, or one or more operations of the method 800 and the method 900 may be implemented using software including computer-executable instructions stored on one or more computer-readable media (e.g., non-transitory computer-readable media, such as one or more optical media discs, volatile memory components (e.g., DRAM or SRAM), or nonvolatile memory or storage components (e.g., hard drives or solid-state nonvolatile memory components, such as Flash memory components)) and executed on a computer (e.g., any suitable computer, such as a laptop computer, net book, Web book, tablet computing device, smart phone, or other mobile computing device). Such software may be executed, for example, on a single local computer or in a network environment (e.g., via the Internet, a wide-area network, a local-area network, a remote web-based server, a client-server network (such as a cloud computing network), or other such network) using one or more network computers. Additionally, any of the intermediate or final data created and used during implementation of the disclosed methods or systems may also be stored on one or more computer-readable media (e.g., non-transitory computer-readable media) and is considered to be within the scope of the disclosed technology. Furthermore, any of the software-based embodiments may be uploaded, downloaded, or remotely accessed through a suitable communication means. Such suitable communication means includes, for example, the Internet, the World Wide Web, an intranet, software applications, cable (including fiber optic cable), magnetic communications, electromagnetic communications (including RF, microwave, and infrared communications), electronic communications, or other such communication means.

Although the disclosure has been described with reference to specific exemplary embodiments, it is noted that various modifications and changes may be made to these embodiments without departing from the broad spirit and scope of the disclosure. For example, the various operations, blocks, etc., described herein may be enabled and operated using hardware circuitry (for example, complementary metal oxide semiconductor (CMOS) based logic circuitry), firmware, software and/or any combination of hardware, firmware, and/or software (for example, embodied in a machine-readable medium). For example, the apparatuses and methods may be embodied using transistors, logic gates, and electrical circuits (for example, application specific integrated circuit (ASIC) circuitry and/or in Digital Signal Processor (DSP) circuitry).

Particularly, the server system 1000 (e.g. acquirer server 114) and its various components such as the computer system 1002 and the database 1004 may be enabled using software and/or using transistors, logic gates, and electrical circuits (for example, integrated circuit circuitry such as ASIC circuitry). Various embodiments of the disclosure may include one or more computer programs stored or otherwise embodied on a computer-readable medium, wherein the computer programs are configured to cause a processor or computer to perform one or more operations. A computer-readable medium storing, embodying, or encoded with a computer program, or similar language, may be embodied as a tangible data storage device storing one or more software programs that are configured to cause a processor or computer to perform one or more operations. Such operations may be, for example, any of the steps or operations described herein. In some embodiments, the computer programs may be stored and provided to a computer using any type of non-transitory computer readable media. Non-transitory computer readable media include any type of tangible storage media. Examples of non-transitory computer readable media include magnetic storage media (such as floppy disks, magnetic tapes, hard disk drives, etc.), optical magnetic storage media (e.g. magneto-optical disks), CD-ROM (compact disc read only memory), CD-R (compact disc recordable), CD-R/W (compact disc rewritable), DVD (Digital Versatile Disc), BD (BLU-RAY® Disc), and semiconductor memories (such as mask ROM, PROM (programmable ROM), EPROM (erasable PROM), flash memory, RAM (random access memory), etc.). Additionally, a tangible data storage device may be embodied as one or more volatile memory devices, one or more non-volatile memory devices, and/or a combination of one or more volatile memory devices and non-volatile memory devices. In some embodiments, the computer programs may be provided to a computer using any type of transitory computer readable media. Examples of transitory computer readable media include electric signals, optical signals, and electromagnetic waves. Transitory computer readable media can provide the program to a computer via a wired communication line (e.g. electric wires, and optical fibers) or a wireless communication line.

Various embodiments of the disclosure, as discussed above, may be practiced with steps and/or operations in a different order, and/or with hardware elements in configurations, which are different than those which, are disclosed. Therefore, although the disclosure has been described based upon these exemplary embodiments, it is noted that certain modifications, variations, and alternative constructions may be apparent and well within the spirit and scope of the disclosure.

Although various exemplary embodiments of the disclosure are described herein in a language specific to structural features and/or methodological acts, the subject matter defined in the appended claims is not necessarily limited to the specific features or acts described above. Rather, the specific features and acts described above are disclosed as exemplary forms of implementing the claims.

1. A computer-implemented method for providing a loyalty program to a merchant, the method comprising:
receiving, by a server system associated with a payment network, a payment transaction request signal from a merchant terminal, the payment transaction request signal comprising a unique identifier data associated with a user and a payment amount for a payment transaction to the merchant, the unique identifier data stored in a payment card of the user by restoring from another payment card of the user having a lost status;
accessing, by the server system, a merchant identifier data associated with the merchant upon successful authorization of the payment transaction request signal;
accessing, by the server system, a loyalty program ruleset for the loyalty program using the merchant identifier data and the unique identifier data that is restored in the payment card from the other payment card of the user having the lost status, the loyalty program ruleset being generated for the merchant using a loyalty calculation parameter and a loyalty redemption parameter, the loyalty program ruleset being stored in a database using the merchant identifier data;
updating, by the server system, the payment amount, that was received in the payment transaction request signal from the merchant terminal, based on the loyalty program ruleset;
sending, by the server system, an updated payment transaction request signal based on an updated payment amount to an issuer of the user via the payment network; and
notifying, by the server system, a completion of the payment transaction to the merchant upon receipt of the updated payment amount from the issuer.

2. The method as claimed in claim 1, wherein the payment transaction request signal is received via a communication interface through one or more application programming interface (API) calls from the merchant terminal associated with the merchant, the method further comprising:
capturing the unique identifier data from the payment card of the user upon swiping the payment card at the merchant terminal by the merchant, the unique identifier data issued by the issuer; and
appending the unique identifier data to the payment transaction request signal.

3. The method as claimed in claim 2, wherein the server system is an acquirer server and wherein the method further comprises:
receiving a registration request signal for registering the merchant for the loyalty program;
receiving a merchant data upon registration of the merchant, the merchant data comprising one or more of a merchant name, a merchant category code, a merchant brand name, a merchant address, a contact number of the merchant and a payment account of the merchant;
assigning the merchant identifier data for the merchant based on receiving the merchant data; and
storing the merchant data using the merchant identifier data in a database.

4. The method as claimed in claim 1, further comprising creating the loyalty program for the merchant based on the loyalty program ruleset.

5. The method as claimed in claim 4, further comprising:
generating a loyalty summary data for the loyalty program; and
storing the loyalty summary data in the database using the merchant identifier data and the unique identifier data.

6. The method as claimed in claim 1, wherein updating the payment amount comprises:
mapping the payment amount into a loyalty point data using the loyalty program ruleset; and
modifying the payment amount based on the mapping.

7. The method as claimed in claim 6, wherein modifying the payment amount comprises:
determining a redeemability of a total redeemable loyalty points from the loyalty point data;
verifying whether the total redeemable loyalty points exceed a pre-defined number of loyalty points, the pre-defined number of loyalty points determined based on the loyalty program ruleset;
deducting a redeemable loyalty points from the total redeemable loyalty points based on a verification; and
adjusting the payment amount based on a deduction.

8. The method as claimed in claim 7, wherein the redeemability is determined based on at least:
a historical data of payment transactions of the user for purchasing from the merchant; and
an availability of loyalty points earned by the user corresponding to the purchasing.

9. The method as claimed in claim 8, further comprising:
upon receipt of an approval for the payment transaction, determining loyalty reward points for the user using the loyalty program ruleset;
updating a loyalty summary data based on a loyalty reward points data, the loyalty summary data accessed using the merchant identifier data and a user data; and
notifying an updated loyalty summary data to the merchant.

10. A server system for providing a loyalty program to a merchant, the system comprising:
a memory comprising stored instructions; and
a processor configured to execute the stored instructions to cause the system to perform at least in part to:
receive a payment transaction request signal from a merchant terminal, the payment transaction request signal comprising a unique identifier data associated with a user and a payment amount for a payment transaction to the merchant, the unique identifier data stored in a payment card of the user by restoring from another payment card of the user having a lost status;
access a merchant identifier data associated with the merchant upon successful authorization of the payment transaction request signal;
access a loyalty program ruleset for the loyalty program using the merchant identifier data and the unique identifier data that is restored in the payment card from the other payment card of the user having the lost status, the loyalty program ruleset being generated for the merchant using a loyalty calculation parameter and a loyalty redemption parameter, the loyalty program ruleset being stored in a database using the merchant identifier data;
update the payment amount, that was received in the payment transection request signal from the merchant terminal, based on the loyalty program ruleset,
send an updated payment transaction request signal based on an updated payment amount to an issuer of the user via a payment network; and
notify a completion of the payment transaction to the merchant upon receipt of the updated payment amount from the issuer.

11. The server system as claimed in claim 10, wherein the server system is further caused to perform at least in part to:
capture the unique identifier data from the payment card of the user upon swiping the payment card at the merchant terminal by the merchant, the unique identifier data issued by the issuer; and
append the unique identifier data to the payment transaction request signal.

12. The server system as claimed in claim 11, wherein the server system is an acquirer server, and wherein the server system is further caused to perform at least in part to:
receive a registration request signal for registering the merchant for the loyalty program;
receive a merchant data upon registration of the merchant, the merchant data comprising one or more of a merchant name, a merchant category code, a merchant brand name, a merchant address, a contact number of the merchant and a payment account of the merchant;
assign the merchant identifier data for the merchant based on receiving the merchant data; and
store the merchant data using the merchant identifier data in a database.

13. The system as claimed in claim 10, wherein the server system is further caused to perform at least in part to create the loyalty program for the merchant based on the loyalty program ruleset.

14. The server system as claimed in claim 13, wherein the server system is further caused to perform at least in part to:
generate a loyalty summary data for the loyalty program; and
store the loyalty summary data in the database using the merchant identifier data and the unique identifier data.

15. The server system as claimed in claim 10, wherein for updating the payment amount, the server system is further caused to perform at least in part to:
map the payment amount into a loyalty point data using the loyalty program ruleset; and
modify the payment amount based on a deduction.

16. The server system as claimed in claim 15, wherein for modifying the payment amount, the server system is further caused to perform at least in part to:
determine a redeemability of a total redeemable loyalty points from the loyalty point data;
verify whether the total redeemable loyalty points exceed a pre-defined number of loyalty points, the pre-defined number of loyalty points determined based on the loyalty program ruleset;
deduct a redeemable loyalty points from the total redeemable loyalty points based on a verification; and
adjust the payment amount based on a deduction.

17. The server system as claimed in claim 16, wherein the redeemability is determined based on at least:
a historical data of payment transactions of the user for purchasing from the merchant; and
an availability of loyalty points earned by the user corresponding to the purchasing.

18. The server system as claimed in claim 17, wherein the server system is further caused to perform at least in part to:
upon receipt of an approval for the payment transaction, determine a loyalty reward points for the user using the loyalty program ruleset;
update a loyalty summary data based on a loyalty reward point data; and
notify an updated loyalty summary data to the merchant.

19. A method for providing a loyalty program to a merchant, the method comprising:
receiving, by a server system associated with a payment network, a payment transaction request signal from a merchant terminal, the payment transaction request signal comprising a unique identifier data associated with a user and a payment amount for a payment transaction to the merchant, the unique identifier data stored in a payment card of the user by restoring from another payment card of the user having a lost status;
accessing, by the server system, a merchant identifier data associated with the merchant upon successful authorization of the payment transaction request signal;
accessing, by the server system, a loyalty program ruleset of the loyalty program using the unique identifier data that is stored in the payment card from the other payment card of the user having the lost status and the merchant identifier data, the loyalty program ruleset being generated for the merchant using a loyalty calculation parameter and a loyalty redemption parameter, the loyalty program ruleset being stored in a database using the merchant identifier data;
mapping, by the server system, the payment amount into a loyalty point data using the loyalty program ruleset;
determining, by the server system, a redeemability of a total redeemable loyalty points from the loyalty point data;
updating, by the server system, the payment amount, that was received in the payment transaction request signal from the merchant terminal, based on deducting a redeemable loyalty points;
sending, by the server system, an updated payment transaction request signal based on an updated payment amount to an issuer of the user via the payment network;
upon receipt of an approval of the payment transaction, determining, by the server system, loyalty reward points for the user using the loyalty program ruleset;
updating, by the server system, a loyalty summary data for the loyalty program based on the loyalty reward points, the loyalty summary data accessed using the merchant identifier data and the unique identifier data; and
notifying, by the server system, an updated loyalty summary data to the merchant.

20. The method as claimed in claim 19, wherein the server system is an acquirer server and wherein updating the payment amount comprises:
verifying, by the server system, whether the total redeemable loyalty points exceed pre-defined number of loyalty points, the pre-defined number of loyalty points determined based on the loyalty program ruleset;
deducting, by the server system, the redeemable loyalty points from the total redeemable loyalty points based on a verification; and
adjusting, by the server system, the payment amount based on a deduction.
